(19) United States
(12) Patent Application Publication
(10) Pub. No.: US 2025/0095614 A1
(43) Pub. Date: Mar. 20, 2025

(54) PERCUSSIVE INSTRUMENT CONTAINING BEADS

(71) Applicant: Parish Drum Designs, LLC, Midlothian, TX (US)

(72) Inventors: John Owen Parish, Midlothian, TX (US); Shane Everett, Dallas, TX (US)

(73) Assignee: Parish Drum Designs, LLC, Midlothian, TX (US)

(21) Appl. No.: 18/368,359

(22) Filed: Sep. 14, 2023

(51) Int. Cl. G10D 13/02; G10D 13/20

(52) U.S. Cl. CPC G10D 13/02; G10D 13/20

(57) ABSTRACT

A percussive instrument including a drum and a plurality of beads, wherein the plurality of beads are contained within the body of the drum such that striking the drum agitates the beads to create a sustained sound. The drum includes a shell, at least two hoops, at least two membranes, a plurality of lugs, and a plurality of tension rods.

### BACKGROUND OF THE INVENTION

### 1. Field of the Invention

The present invention relates to percussion instruments, and more specifically to drums including bead elements in addition to or in lieu of snare wires.

### 2. Description of the Prior Art

It is generally known in the prior art to provide percussive instruments containing beads or bead-like objects.

Prior art patent documents include the following:

U.S. Pat. No. 9,734,807 for Musical instrument multiple membrane percussion and shaking by inventor Martinelli, filed Aug. 11, 2016, and issued Aug. 15, 2017, is directed to musical instruments of the type called “ocean drum” provided with three or more vibratile membranes, in the interspaces of which some balls of different materials and diameters, phosphorescent as well, are inserted. By tilting said drum, provided with two or more planes bearing some balls, the latter roll on the internal surface of the membranes produces sounds that evoke sea waves. Said “ocean drum” has a plurality of rings with a common central axis, aligned in a fixed way to enable the insertion of three or more vibratile membranes between them. Said rings are made of laminated plywood, solid wood or plastic material. They are glued, without discontinuity, to the circular membranes made of animal leather, or of polymer films provided with holes on a median diameter of the rings for more resistant gluing.

U.S. Pat. No. 8,933,311 for Snare drum by inventor Hashimoto, filed Jul. 18, 2013, and issued Jan. 13, 2015, is directed to a snare drum which has a hollow cylindrical shell, a batter head mounted on one end of the shell, a snare side head mounted on the other end of the shell and a snare wire whose both ends are held by the both sides of the shell to span across the surface of the snare side head. The snare side head has a plurality of through-holes. As a result, the snare drum reduces sound volume while maintaining natural timbre and feeling of striking a snare drum.

U.S. Pat. No. 7,910,816 for Circular percussive sound generation instrument by inventor Glowacki, filed Apr. 29, 2009, and issued Mar. 22, 2011, is directed to a percussion instrument which incorporates a case with an inner surface having a substantially circular profile. Multiple high precision spherical balls are contained with the case for acceleration on the inner surface in uniform circular motion along the profile to produce a persistent sustained sound. In one exemplary embodiment the case is cylindrical and incorporates two end plates. In a second embodiment the percussion instrument case is torroidal. In a third embodiment the percussion instrument case is spherical. Use of varying materials in the case or differing surface textures on the inner surface allows timbre of the instrument to be modified. Motion of the instrument lateral or perpendicular to the circular profile allows the creation of pulsed percussion sounds.

U.S. Pat. No. 10,685,632 for Percussion musical instrument with snare effect assembly by inventors Metz, et al., filed Aug. 29, 2017 and issued Jun. 16, 2020, is directed to a percussion instrument including a box with at least one wall configured to define a resonant chamber. The at least one wall defines a support area about an opening into the resonant chamber with the support area extending in a support plane. A playing surface is configured to be mounted to the support area to close the opening such that an inner surface of the playing surface extends along the support plane. At least one arcuate string is mounted relative to the at least one wall at an angle such that a portion of the arcuate string is in biased engagement with a contact surface defined by an inner surface of the playing surface or an inner surface of a portion of the at least one wall.

U.S. Pat. No. 11,183,158 for Systems, devices, and/or methods for snare drums by inventor Stecher, filed on Jan. 24, 2019 and issued Nov. 23, 2021, is directed to a snare drum system comprising a shell, a batter head, a snare head, and a set of wires coupled to the snare head. The system comprises a tensioner coupleable to the set of wires of the snare drum. The tensioner comprising a base, a coarse adjuster, and a fine adjuster.

U.S. Pat. No. 11,189,255 for Film formed snare and reduced volume snare drumhead by inventors Gorman, et al., filed Sep. 18, 2020 and issued Nov. 30, 2021, is directed to a snare unit formed from film material includes a plurality of slots that define segments. The snare unit is attachable relative to a drumhead with a surface of the film flat against a surface of the drumhead. In the attached position, one or more of the segments vibrates against the drumhead when the drumhead is struck to produce a snare-like audible sound. In a drumhead with reduced volume, the snare unit is positioned flat against one or more layers of a porous material to define a drumhead and attached such that a portion of the snare unit vibrates against a surface of the porous material when the drumhead is struck, thereby producing a snare-like sound having a volume reduced relative to a standard drumhead.

U.S. Pat. No. 8,586,846 for Set of snares for a drum by inventor Ehmann, filed Jul. 25, 2012 and issued Nov. 19, 2013, is directed to a set of snares for a drum comprising an elongated first wire with two ends to be placed at least in part against a surface of a head of the drum and a first and one second fastening means for fastening the set of snares to the snare drum, wherein the first end of the first wire is attached to the first fastening means and the second end of the first wire is attached to the second fastening means, wherein the first wire runs between the two fastening means, wherein the first wire is shaped such that, at least along a partial section of the first wire, it follows an envelope body, the outer dimensions of which in the assembled state of the set of snares on the drum vary in a plane extending from the first fastening means to the second fastening means and intersecting the surface of the head of the drum.

### SUMMARY OF THE INVENTION

The present invention relates to percussion instruments, and more specifically to drums including bead elements in addition to or in lieu of snare wires.

It is an object of the invention to create an instrument which provides a sound which is softer and more sustained that that of similar percussive instruments.

In one embodiment, the present invention includes a percussion instrument, comprising: a shell; two hoops; a plurality of tensioners; two vibratile membranes; and a plurality of beads; wherein the two hoops are operable to surround the distal ends of the shell; wherein the two vibratile membranes are operable to stretch across the two hoops such that the shell, hoops, and membranes create a sealed container; and wherein the plurality of beads are housed within the container.

In another embodiment, the present invention includes a percussion instrument, comprising: a shell; a plurality of hoops; a plurality of tensioners; a plurality of vibratile membranes; and a plurality of beads; wherein the plurality of tensioners include a plurality of tension rods and a plurality of lugs; wherein the plurality of vibratile membranes are operable to stretch across the plurality of hoops such that the shell, hoops, and membranes create a plurality of percussion chambers; and wherein the plurality of beads are housed within at least one of the plurality of percussion chambers.

In yet another embodiment, the present invention includes a system, comprising: a drum; and a plurality of beads; wherein the drum includes a shell, at least two hoops, at least two vibratile membranes, a plurality of tension rods, and a plurality of lugs; and wherein the plurality of beads are housed within the drum.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a perspective view of a drum according to one embodiment of the present invention.

FIG. 2 illustrates a perspective side view of a drum according to one embodiment of the present invention.

FIG. 3 illustrates an orthogonal side view of a drum according to one embodiment of the present invention.

### DETAILED DESCRIPTION

The present invention is generally directed to percussion instruments, and more specifically to drums including bead elements in addition to or in lieu of snare wires.

In one embodiment, the present invention includes a percussion instrument, comprising: a shell; two hoops; a plurality of tensioners; two vibratile membranes; and a plurality of beads; wherein the two hoops are operable to surround the distal ends of the shell; wherein the two vibratile membranes are operable to stretch across the two hoops such that the shell, hoops, and membranes create a sealed container; and wherein the plurality of beads are housed within the cylindrical container.

In another embodiment, the present invention includes a percussion instrument, comprising: a shell; a plurality of hoops; a plurality of tensioners; a plurality of vibratile membranes; and a plurality of beads; wherein the plurality of tensioners include a plurality of tension rods and a plurality of lugs; wherein the plurality of vibratile membranes are operable to stretch across the plurality of hoops such that the shell, hoops, and membranes create a plurality of percussion chambers; and wherein the plurality of beads are housed within at least one of the plurality of percussion chambers.

In yet another embodiment, the present invention includes a system, comprising: a drum; and a plurality of beads; wherein the drum includes a shell, at least two hoops, at least two vibratile membranes, a plurality of tension rods, and a plurality of lugs; and wherein the plurality of beads are housed within the drum.

None of the prior art discloses a percussive instrument containing beads which includes a wooden shell, hoops, lugs, and tension rods.

The intensity of a drum's sound often causes the instrument to be too loud and not appropriate in some settings. Historically, there are a few approaches to solving this problem—drum shields, electronic drum kits, drum mute pads—but these approaches come at a cost. Drum shields are sound-dampening panels that surround a drum set. However, these shields are large, conspicuous, and expensive in addition to compromising the ability to record individual sound sources. Electronic drum kits allow for adjustments in volume but at the cost of the sound, feel, and look of an acoustic set, which often have a significant impact on a musical piece, and electronic drum kits don't allow for physical experimentation with the drum itself. Drum mute pads are useful for low-volume practicing but significantly reduce sound quality when used in a performance setting. Thus, there a exists a need for a less obtrusive drum that does not sacrifice sound quality or require expensive equipment to dampen sound.

Some drums are designed to produce softer, more sustained sounds than traditional drum kits. For example, the “ocean drum” is a small drum with round beads inside. When the drum is percussed, the small beads continue to bounce, absorbing some of the transmitted energy and producing a softer, drawn-out sound that is reminiscent of ocean sounds. However, existing ocean drums are formed as a single piece, with the drum skin permanently attached to the body, and with no way to tune the drum or change the skin. Existing ocean drums are also quite small and not compatible to be used as part of a drum set. Therefore, there exists a need for a larger drum which produces similar sounds but is able to be used as part of a complete drum set, which is able to be tuned, and which includes replaceable parts.

The present invention includes a drum and a plurality of beads housed within the drum, wherein the drum includes a wooden shell, a plurality of tensioners, at least two membranes, and at least two hoops.

Referring now to the drawings in general, the illustrations are for the purpose of describing one or more preferred embodiments of the invention and are not intended to limit the invention thereto.

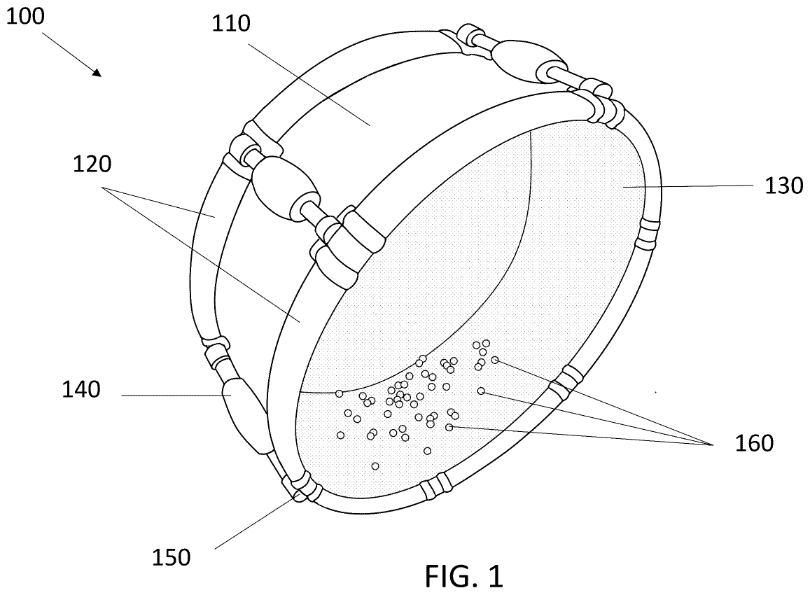

As shown in FIG. 1, in one embodiment the present invention includes a drum 100 and a plurality of beads 160 housed within the drum 100. The drum 100 includes a shell 110, forming a side wall of the drum 100. In one embodiment, the drum 100 is substantially circular in shape and therefore the shell 110 is substantially cylindrical, but one of ordinary skill in the art will understand that other shapes are also contemplated herein. At least one hoop 120 is attached to either end of the shell 110 with an outer rim of at least one vibrating membrane 130 held across a face of the shell 110 by the attachment of the hoop 120 and the shell 110. Therefore, in constructing the drum, the vibrating membranes 130 are first placed across the open ends of the shell 110, and the at least one hoop 120 is then connected to the shell, binding the vibrating membranes 130 to the shell 110. In this way, in one embodiment, removing the hoop 120 from the shell 110 allows the at least one vibrating membrane 130 to be removed, repaired, or replaced. In one embodiment, a plurality of lugs 150 secure the at least one hoop 120 to the shell 110. The drum 100 includes a plurality of tension rods 140 connecting a hoop 120 on one side of the shell 110 to a hoop 120 on the other side of the shell 110. In one embodiment, the tension rods 140 include at least one knob operable to tight the tension rod 140 (i.e., force the hoops 120 on either side of the shell 110 closer together) and/or slacken the tension rod 140 (i.e., reducing the tensile force holding the hoops 120 on either side of the shell 110 together).

The combination of the detachable vibrating membranes 130 and the adjustable tension rods 140 provide a stark contrast with other drums, such as ocean drums, that utilize beads for producing sound. The system therefore has the benefit of adjustability and adaptability while having a distinct sound profile relative to snare drums that utilize snare wire as the rattle.

One of ordinary skill in the art will understand that various prior art methods are able ot be used to attach the at least one hoop 120 to the shell 110 including, but not limited to, those described in U.S. Pat. Nos. 7,223,910, 8,933,311, and 7,741,550, each of which is incorporated herein by reference in its entirety.

In one embodiment, the shell is made from wood, including, but not limited to, maple, birch, beech, oak, poplar, cedar, mahogany, walnut, cherry, bubinga, basswood, and/or ash. In one embodiment, the shell is made from metal, including, but not limited to, steel, brass, aluminum, copper, bronze, and/or titanium. In one embodiment, the shell is made from synthetic materials, including, but not limited to, carbon fiber, acrylic, and/or fiberglass. In one embodiment, the shell is substantially cylindrical in shape. In one embodiment, the shell is tapered such that the bottom of the shell is narrower than the top. In one embodiment, the shell includes at least one vent hole, allowing air to pass into and out of the shell, and providing for a different sound.

In one embodiment, the beads are substantially spherical in shape. In one embodiment, the beads are a mixture of differing shapes. In one embodiment, the beads are formed from materials including, but are not limited to, metal, wood, plastic, glass, and/or stone. In one embodiment, the beads are a mixture of differing materials. One of ordinary skill in the art will appreciate that the beads are able to be formed from a variety of different materials and in a variety of different shapes and/or sizes to produce a range of sounds. In a preferred embodiment, the drum 100 does not include any snare wire, instead relying entirely on the sound of the beads. Importantly, the removability of the vibrating membranes exposes the interior of the drum 100, allowing for replacement of the type of beads and therefore allowing for different sound profiles to be customized for each drum, in contrast to ocean drums where new drums need to be created for different sets of beads, or the drums need to be torn apart and repaired in order to change components.

In one embodiment, the at least one vibrating membrane includes, but is not limited to, polymers such as biaxially-oriented polyethylene terephthalate (MYLAR) or polyester, natural or synthetic animal skin, aramid fibers such as KEVLAR, and/or woven fibers. In one embodiment, the at least one vibrating membrane is formed from a single layer of material. In one embodiment, the at least one vibrating membrane is formed from more than one layer.

In one embodiment, the present invention includes more than two vibrating membranes such that the drum includes at least two percussive chambers. In one embodiment, the beads are contained within each of the at least two percussive chambers. In one embodiment, the beads are contained within at least one of the percussive chambers.

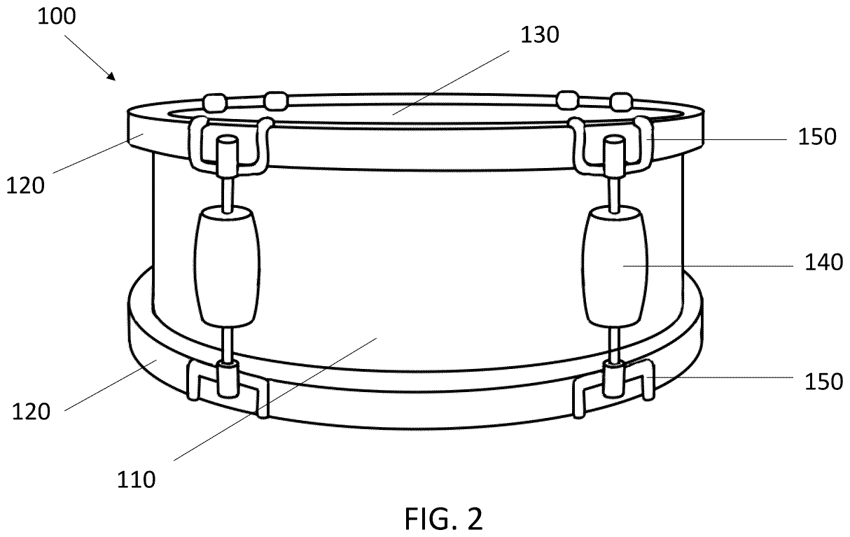

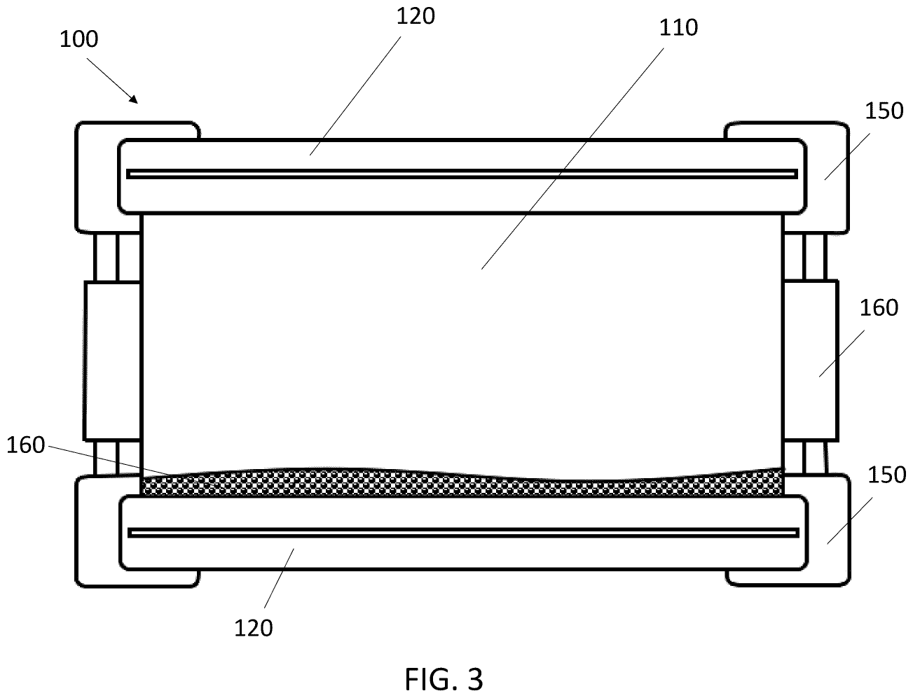

FIGS. 2 and 3 show a drum 100 and a plurality of beads 160 housed within the drum, wherein the drum includes a shell 110, a plurality of tension rods 140, a plurality of lugs 150, two hoops 120, and at least one vibrating membrane 130.

In one embodiment, the drum includes a plurality of tension rods and a plurality of lugs, wherein the lugs are coupled to each end of the tension rods, such that each tension rod is coupled to two lugs. In one embodiment, the plurality of tension rods are formed from materials selected from a set including, but are not limited to, stainless steel, brass, and/or nickel. In one embodiment, the plurality of lugs are formed from materials selected from a set including, but art not limited to, stainless steel, brass, and/or nickel. In one embodiment, the plurality of tension rods include at least one knob which is operable to adjust the tension in the tension rods. In one embodiment, the lugs are coupled to each of the two hoops to provide force that keeps the hoops in place on the shell.

In one embodiment, the drum includes two hoops which are coupled to the distal ends of the shell so as to hold the membranes in place across the shell openings. In one embodiment, the hoops are single-flanged. In one embodiment, the hoops are double-flanged. In one embodiment, the hoops are triple-flanged. In one embodiment, the hoops are zero-flange. In one embodiment, the hoops are die-cast. In one embodiment, the hoops are S-hoops. In one embodiment, the hoops include, but are not limited to, steel, brass, aluminum, zinc, and/or wood.

In one embodiment, the drum is operable to be disassembled such that the shell, hoops, tensioners, membranes, and/or beads are able to be replaced. In one embodiment, the vibrating membranes are not adhesively or otherwise chemically bonding to the shell. In one embodiment, the vibrating membranes are not adhesively or otherwise chemically bonding to the at least one hoop. This lack of permanent bonding between components is a major factor in what enables the replaceability and repairability of the drum, therefore providing a major advantage over ocean drums.

The above-mentioned examples are provided to serve the purpose of clarifying the aspects of the invention, and it will be apparent to one skilled in the art that they do not serve to limit the scope of the invention. By nature, this invention is highly adjustable, customizable and adaptable. The above-mentioned examples are just some of the many configurations that the mentioned components can take on. All modifications and improvements have been deleted herein for the sake of conciseness and readability but are properly within the scope of the present invention.

The invention claimed is:

1. A percussion instrument, comprising:
a cylindrical shell open at both ends;
a first hoop attached to a first end of the cylindrical shell and a second hoop attached to a second end of the cylindrical shell;
a plurality of tensioners extending between the first hoop and the second hoop;
a first vibration membrane covering the first end of the cylindrical shell and a second vibration membrane covering the second of the cylindrical shell; and
a plurality of beads;
wherein the first hoop and the second hoop are operable to surround the distal ends of the shell;
wherein the first vibration membrane and the second vibration membrane are stretched across the first hoop and the second hoop, respectively, such that the cylindrical shell, the first membrane, and the second membrane create an internal container; and
wherein the plurality of beads are housed within the internal container.

2. The percussion instrument of claim 1, wherein the percussion instrument does not include any snare wires.

3. The percussion instrument of claim 1, wherein the cylindrical shell is formed from wood.

4. The percussion instrument of claim 1, wherein the two vibration membranes are substantially circular in shape.

5. The percussion instrument of claim 1, wherein the first vibration membrane is held in connection with the cylindrical shell via the attachment of the first hoop to the cylindrical shell, and the second vibration membrane is held in connection with the cylindrical shell via the attachment of the second hoop to the cylindrical shell.

6. The percussion instrument of claim 1, wherein the plurality of tensioners include a plurality of tension rods and a plurality of lugs.

7. The percussion instrument of claim 6, wherein one of the plurality of lugs are coupled each end of each of the plurality of tension rods.

8. The percussion instrument of claim 1, wherein the cylindrical shell includes at least one vent hole.

9. The percussion instrument of claim 1, wherein the plurality of tensioners include at least one knob, wherein the at least one knob is operable to adjust tension of the plurality of tensioners.

10. The percussion instrument of claim 1, wherein the first hoop, the second hoop, the first vibration membrane, and the second vibration membrane are operable to be removed by releasing the tension of the plurality of tensioners.

11. A percussion instrument, comprising:
a cylindrical shell open at both ends;
a first hoop attached to a first end of the cylindrical shell and a second hoop attached to a second end of the cylindrical shell;
a plurality of tensioners extending between the first hoop and the second hoop;
a first vibration membrane covering the first end of the cylindrical shell and a second vibration membrane covering the second of the cylindrical shell; and
a plurality of beads;
wherein the plurality of tensioners include a plurality of tension rods and a plurality of lugs;
wherein the first vibration membrane and the second vibration membrane are stretched across the first hoop and the second hoop, respectively, such that the cylindrical shell, the first membrane, and the second membrane create an internal container; and
wherein the plurality of beads are housed within the internal container.

12. The percussion instrument of claim 11, wherein the cylindrical shell includes at least one vent hole.

13. The percussion instrument of claim 11, wherein the plurality of vibrating membranes are substantially circular in shape.

14. The percussion instrument of claim 11, wherein the percussion instrument does not include any snare wires.

15. The percussion instrument of claim 11, wherein the plurality of tensioners are operable to connect the plurality of hoops to the shell.

16. The percussion instrument of claim 11, wherein the plurality of tensioners include at least one knob, wherein the knob is operable to adjust tension of the plurality of tensioners.

17. The percussion instrument of claim 11, wherein the first hoop, the second hoop, the first vibration membrane, and the second vibration membrane are operable to be removed by releasing the tension of the plurality of tensioners.

18. A percussion instrument, comprising:
a cylindrical shell open at both ends;
a first hoop attached to a first end of the cylindrical shell and a second hoop attached to a second end of the cylindrical shell;
a plurality of tensioners extending between the first hoop and the second hoop;
a first vibration membrane covering the first end of the cylindrical shell and a second vibration membrane covering the second of the cylindrical shell; and
a plurality of beads;
wherein the first vibration membrane and the second vibration membrane are stretched across the first hoop and the second hoop, respectively, such that the cylindrical shell, the first membrane, and the second membrane create an internal container;
wherein the plurality of beads are housed within the internal container; and
wherein the percussion instrument does not include any snare wires.

19. The percussion instrument of claim 18, wherein the cylindrical shell includes at least one vent hole.

20. The percussion instrument of claim 18, wherein the plurality of beads are substantially spherical in shape.
